(19) United States
(12) Patent Application Publication
(10) Pub. No.: US 2007/0063955 A1
(43) Pub. Date: Mar. 22, 2007

(54) Driving device

(76) Inventors: Hung-Shiang Chen, Lujhou City (TW); Juin-Ying Huang, Taoyuan City (TW)

Correspondence Address: J C PATENTS, INC., 4 VENTURE, SUITE 250, IRVINE, CA, 92618, US

(21) Appl. No.: 11/228,556

(22) Filed: Sep. 16, 2005

(51) Int. Cl. G09G 3/36

(52) U.S. Cl. 345/98

(57) ABSTRACT

A driving device, suitable for driving a liquid crystal display panel, comprises a gate driving unit, a source driving unit, a power supply, a unit for reducing tide phenomenon and a current/voltage limit unit. The gate driving unit and the source driving unit are electrically connected with the liquid crystal display panel respectively. The power supply is electrically connected with the gate driving unit and the source driving unit. The unit for reducing tide phenomenon is electrically connected with the gate driving unit, and the current/voltage limit unit is electrically connected with the power supply and the gate driving unit. The current/voltage limit unit is used for limiting the voltages or currents from the power supply to the gate driving unit while reducing the tide phenomenon of the liquid crystal display panel, so as to decrease the possibility of the bonding pads damaged by the rush currents.

### BACKGROUND OF THE INVENTION

1. Field of the Invention

The present invention relates to a driving device suitable for a display panel. More particularly, the present invention relates to a driving device suitable for a liquid crystal display panel.

2. Description of Related Art

With high advance of semiconductor elements and display apparatuses, the multimedia technology is rapidly developed in modern society. As for the display apparatuses, the thin film transistor liquid crystal display (TFT-LCD) apparatuses has gradually become the mainstream in display apparatus markets due to their high display quality, high space utilization, low power consumption and low radiation, etc.

FIG. 1 is a block diagram of a driving device of a conventional liquid crystal display panel. Referring to FIG. 1, the driving device 100 includes a gate driving unit 110, a source driving unit 120, a power supply 130, a timing controller 140 and a unit 150 for reducing tide phenomenon. The gate driving unit 110 and the source driving unit 120 are electrically connected with a plurality of data lines (not shown) and scan lines (not shown) of a liquid crystal display panel 102 respectively. The power supply 130 is electrically connected with the gate driving unit 110, the source driving unit 120 and the timing controller 140, wherein the power supply 130 is utilized for providing the required voltages and currents of driving the liquid crystal display panel 102. The unit 150 for reducing tide phenomenon is electrically connected with the gate driving unit 110. When the power of the liquid crystal display apparatus is turned off, the unit 150 for reducing tide phenomenon outputs a signal to the gate driving unit 110 to turn on a plurality of active devices (not shown) of the liquid crystal display panel 102.

At the moment, because whole active devices (not shown) of the liquid crystal display panel 102 are required to be turned on at the same time, the loading of the power supply 130 will be increased and large rush currents will be momentarily produced from the power supply 130 to the gate driving unit 110. However, as for the present technique of chip on glass (COG), if the parameters for depositing films of the liquid crystal display panel 102 is not appropriate (resulted in such as uniform film of the liquid crystal display panel 102), the bonding pads disposed between the gate driving unit 110 and the liquid crystal display panel 102 will be easily hurt by the large rush currents. With the higher frequency of turning on and off the power of the liquid crystal display apparatuses, the possibility of the bonding pads hurt by the large rush currents will be increased, so as to influence the reliability of the liquid crystal display panel thereof.

### SUMMARY OF THE INVENTION

Accordingly, the present invention is directed to a driving device, suitable for driving a liquid crystal display panel, having a lower possibility of the boning pads hurt by rush currents which are produced by reducing tide phenomenon of the liquid crystal display panel when turned off, so as to enhance the reliability of the liquid crystal display panel.

According to an embodiment of the present invention, a driving device, suitable for driving a liquid crystal display panel, is disclosed. The driving device comprises a gate driving unit, a source driving unit, a power supply, a unit for reducing tide phenomenon and a current/voltage limit unit. The gate driving unit and the source driving unit are electrically connected with the liquid crystal display panel respectively. The power supply is electrically connected with the gate driving unit and the source driving unit, wherein the power supply can provide the required voltages and currents for driving the liquid crystal display panel. The unit for reducing tide phenomenon is electrically connected with the gate driving unit, wherein the unit for reducing tide phenomenon can output signals to the gate driving unit at an appropriate time to reduce tide phenomenon of the liquid crystal display panel when turned off. The current/voltage limit unit is electrically connected with the power supply and the gate driving unit, wherein the current/voltage limit unit can limit the voltages or currents from the power supply to the gate driving unit while reducing the tide phenomenon of the liquid crystal display panel, so as to decrease the possibility of the bonding pads hurt by large rush currents.

According to an embodiment of the present invention, the foregoing driving device further comprises a timing controller, wherein the timing controller can be electrically connected with the power supply, the gate driving unit and the source driving unit to control the operation timing of the gate driving unit and the source driving unit.

According to an embodiment of the present invention, the foregoing current/voltage limit unit comprises a voltage stabilizer and a current limit device, wherein one end of the voltage stabilizer is electrically connected with the aforementioned power supply and another end of the voltage stabilizer is grounding. The current limit device is electrically connected with the foregoing power supply and gate driving unit.

According to an embodiment of the present invention, the above-mentioned current/voltage limit unit comprises a voltage stabilizer and a current limit device, wherein one end of the voltage stabilizer and the current limit device are electrically connected with the foregoing power supply respectively, and another end of the voltage stabilizer and the current limit device are grounding.

According to an embodiment of the present invention, the foregoing voltage stabilizer is a capacitor and the afore-mentioned current limit device is a resistor, for example.

To sum up, the present invention, the driving device, by utilizing the current/voltage limit unit, can impede rush currents while reducing the tide phenomenon of the liquid crystal display panel, so as to lower the possibility of the rush currents impairing the bonding pads of the liquid crystal display panel after the rush currents enters the gate driving unit. Hence, the reliability of the liquid crystal display panel will be increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a driving device of a conventional liquid crystal display panel.

FIG. 2 is a block diagram of a driving device of a liquid crystal display panel according to one embodiment of the present invention.

FIG. 3 is a schematic view of an elementary circuit of a current/voltage limit unit according to one embodiment of the present invention.

FIG. 4 is a schematic view of an elementary circuit of a current/voltage limit unit according to another embodiment of the present invention.

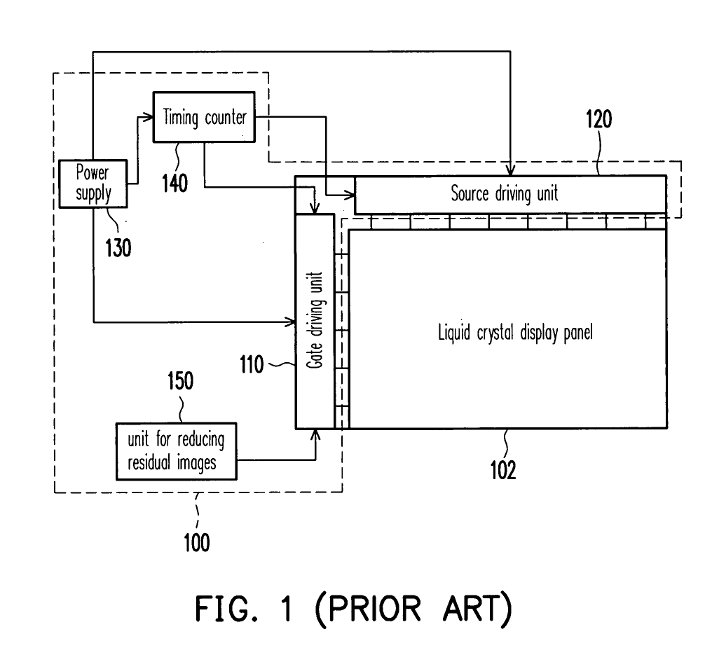

### DESCRIPTION OF THE EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

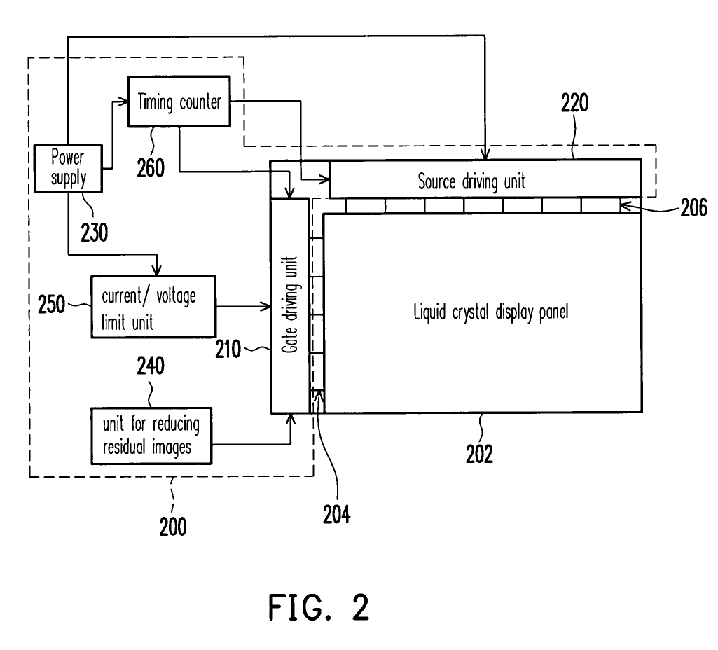

FIG. 2 is a block diagram of a driving device of a liquid crystal display panel according to one embodiment of the present invention. Referring to FIG. 2, the driving device 200 is utilized for driving the liquid crystal display panel 202. The driving device 200 comprises a gate driving unit 210, a source driving unit 220, a power supply 230, a unit 240 for reducing tide phenomenon and a current/voltage limit unit 250. The gate driving unit 210 and the source driving unit 220 are electrically connected with the liquid crystal display panel 202, wherein the gate driving unit 210 can drive a plurality of scan lines 204 and data lines 206 of the liquid crystal display panel 202. The power supply 230 is electrically connected with the gate driving unit 210 and the source driving unit 220, wherein the power supply 230 is utilized for providing the required voltages and currents of driving the liquid crystal display panel 202. The unit 240 for reducing tide phenomenon is electrically connected with the gate driving unit 210. And the current/voltage limit unit 250 is electrically connected with the gate driving unit 210 and the power supply 230 to limit the currents and voltages entering to the gate driving unit 210.

Referring to FIG. 2, in order to reduce the tide phenomenon of liquid crystal display panel 202 when turned off, the unit 240 for reducing tide phenomenon will output signals to the gate driving unit 210 to turn on all active devices (not shown) of the liquid crystal display panel 202, so as to build paths for discharging the residual charges in the liquid crystal display panel 202. It should be noted that the voltages utilized for turning on the active devices is provided by the power supply 230, and the paths for discharging currents from the power supply 230 will be allowed or limited by the current/voltage limit unit 250. Based on the premise that keeping the mechanism for reducing tide phenomenon of the liquid crystal display panel 202, the voltages output from the power supply 230 can be lowered to ground level to impede the rush currents, so as to reduce the possibility that the exceeding voltages or currents damage the liquid crystal display panel 202.

Additionally, the driving device 200 further comprises a timing controller 260, wherein the timing controller 260 can be electrically connected with the power supply 230, the gate driving unit 210 and the source driving unit 220 to control the timing for turning on the gate driving unit 210 and the source driving unit 220. And the required voltages and currents of the timing controller 260 are provided by the power supply 230.

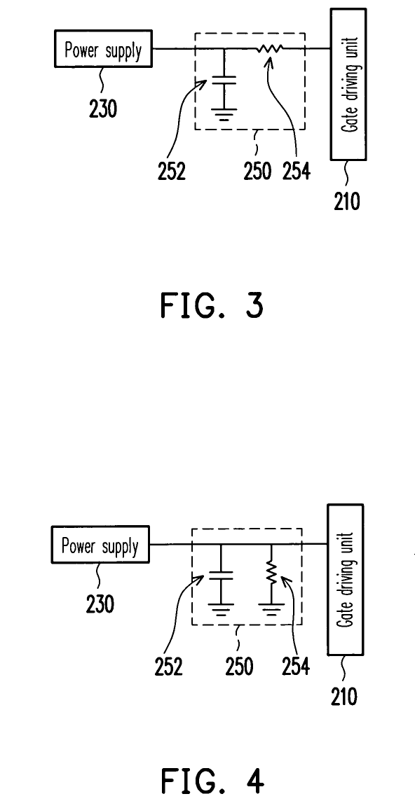

FIG. 3 is a schematic view of an elementary circuit of a current/voltage limit unit according to one embodiment of the present invention. Referring to FIG. 3, the current/voltage limit unit 250 comprises a voltage stabilizer 252 and a current limit device 254, for example. The voltage stabilizer 252 is utilized for filtering and stabilizing the voltages provided by the power supply 230, and the current limit device 254 is used for limiting the currents entering the gate driving unit 210. In one embodiment, the voltage stabilizer 252 is a capacitor, for instance, wherein one end of the voltage stabilizer 252 is electrically connected with the power supply 230 and another end of the voltage stabilizer 252 is grounding. On the other hand, the current limit device 254 is a resistor, for example, wherein the current limit device 254 is electrically connected with the power supply 230 and the gate driving unit 210.

Additionally, in another embodiment shown in FIG. 4, the current/voltage limit unit 250 can also comprise a voltage stabilizer 252 and a current limit device 254, for example, wherein the voltage stabilizer 252 and the current limit device 254 are electrically connected in parallel. One end of the voltage stabilizer 252 and the current limit device 254 are electrically connected with the power supply 230 respectively and another end of the voltage stabilizer 252 and the current limit device 254 are grounding. Similarly, in the present embodiment, the voltage stabilizer 252 can be a capacitor and the current limit device 254 can be a resistor, for example. More particularly, in the present embodiment, the current limit device 254 can provide a path for discharging to increase the speed of discharging voltages and to reduce the currents entering the gate driving unit 210. In addition, the voltage stabilizer 252 can be used for adjusting the time for discharging to keep the mechanism for solving the problem about tide phenomenon of the liquid crystal display panel 202 when the liquid crystal display panel 202 is turned off.

It should be noted that the current/voltage limit unit 250 shown in FIG. 3 and FIG. 4 is taken an example in the present invention, anyone skilled in the art appreciates that the current/voltage limit unit 250 can also be composed of other active or passive devices. In other words, the current/voltage limit unit 250 is not limited by the present invention.

In summary, the present invention, the driving device, has a current/voltage limit unit disposed between a power supply and a gate driving unit to limit the voltages and currents entering the gate driving unit, so the rush currents momentarily output from the power supply can be impeded by the current/voltage limit unit while reducing the tide phenomenon of the liquid crystal display panel. Consequently, in the liquid crystal display panel made by chip on glass (COG) technique, the problem that the rush currents impairing the bonding pads utilized for electrically connected with the gate driving unit and the liquid crystal display panel will be reduced so as to enhance the reliability of the liquid crystal display panel further.

The above description provides a full and complete description of the embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A driving device, suitable for driving a liquid crystal display panel, comprising:
a gate driving unit, electrically connected with the liquid crystal display panel;
a source driving unit, electrically connected with the liquid crystal display panel;
a power supply, electrically connected with the gate driving unit and the source driving unit;
a unit for reducing tide phenomenon, electrically connected with the gate driving unit; and
a current/voltage limit unit, electrically connected with the power supply and the gate driving unit.

2. The driving device of claim 1, further comprising a timing controller, electrically connected with the power supply, the gate driving unit and the source driving unit.

3. The driving device of claim 1, wherein the current/voltage limit unit further comprises:
a voltage stabilizer, wherein one end of the voltage stabilizer is electrically connected with the power supply, and another end of the voltage stabilizer is grounding; and
a current limit device, electrically connected with the power supply and the gate driving unit.

4. The driving device of claim 3, wherein the voltage stabilizer comprises a capacitor.

5. The driving device of claim 3, wherein the current limit device comprises a resistor.

6. The driving device of claim 1, wherein the current/voltage limit unit comprises:
a voltage stabilizer, wherein one end of the voltage stabilizer is electrically connected with the power supply, and another end of the voltage stabilizer is grounding; and
a current limit device, wherein one end of the current limit device is electrically connected with the power supply, and another end of the current limit device is grounding.

7. The driving device of claim 6, wherein the voltage stabilizer comprises a capacitor.

8. The driving device of claim 6, wherein the current limit device comprises a resistor.
